(19) United States
(12) Patent Application Publication
(10) Pub. No.: US 2017/0154038 A9
(43) Pub. Date: Jun. 1, 2017

(54) METHOD AND DEVICE FOR MANAGING PICTURES OF MOBILE TERMINAL

(71) Applicant: Tencent Technology (Shenzhen) Company Limited, Shenzhen (CN)

(72) Inventors: Yang Li, Shenzhen (CN); Yongjian Wu, Shenzhen (CN); Yucun Pan, Shenzhen (CN); Xuezhi Chai, Shenzhen (CN)

(73) Assignee: Tencent Technology (Shenzhen) Company Limited, Shenzhen (CN)

(21) Appl. No.: 14/165,165

(22) Filed: Jan. 27, 2014

Related U.S. Application Data
(63) Continuation of application No. PCT/CN2012/086544, filed on Dec. 13, 2012.

(30) Foreign Application Priority Data
Dec. 27, 2011 (CN) 201110444370.0

(51) Int. Cl. G06F 17/30

(52) U.S. Cl. CPC G06F 17/3007; G06F 17/30244

(57) ABSTRACT

The present invention discloses a method and a device for managing pictures of a mobile terminal, where a log file is set on the mobile terminal to record picture file information and/or picture file storage directory information. The method includes: monitoring, by the mobile terminal, changes of picture files and changes of a storage directory of the picture files, and updating the log file according to the detected changes if any change of the picture files or change of the storage directory of the picture files is detected; and providing, by the mobile terminal, the log file to other terminal device when the mobile terminal is connected to the other terminal device so that the other terminal device manages the picture files on the mobile terminal according to the log file.

### CROSS REFERENCE TO RELATED APPLICATIONS

This application is a continuation of International Application No. PCT/CN2012/086544, filed on Dec. 13, 2012, which claims priority to Chinese Patent Application No. 201110444370.0, filed with the Chinese Patent Office on Dec. 17, 2011 and entitled “METHOD AND DEVICE FOR MANAGING PICTURES OF MOBILE TERMINAL”, which are hereby incorporated by reference in their entirety.

### FIELD OF THE TECHNOLOGY

The present invention relate to the field of communication technologies, and in particular, to a method and a device for managing pictures of a mobile terminal.

### BACKGROUND OF THE TECHNOLOGY

With rapid development of multimedia and computer technologies, mobile terminals come in more and more types. For example, smart-phones, tablets, handwriting computers, and so on, are also more and more popular, and play an indispensable role in everyday life of people. Such mobile terminals provide powerful functions in terms of photographing, picture browse, and picture processing, which imposes higher requirements on picture management.

Currently, most types of picture management software such as Picassa in other terminal devices (for example, PC, notebook computer, and so on) do not perform special picture synchronization processing for mobile terminals capable of independent operation, but perform conventional scan or run a background process on other terminal devices to monitor data update of pictures.

When pictures are managed on a PC, as regards an ordinary NTFS formatted disk, an NTFS Change Journal (a log file maintained by an NTFS file system) may monitor changes of picture files or directory of a partition. When a mobile terminal is connected with other terminal device by means of such as a data cable or WIFI, the picture management software generally manages the mobile terminal as a disk. However, no log file similar to the NTFS Change Journal is maintained in the mobile terminal, which makes it difficult to monitor the changes of the picture files and directory.

Currently, the picture management software applied on the other terminal device monitors the change of picture files by scanning the picture files of the mobile terminal or running a process on the other terminal device when synchronizing picture information of the mobile terminal. However, the picture management software is unable to keep monitoring continuously after the mobile device is disconnected from the other terminal device, and has to perform scan again or run the process again when the connection is recovered. With increase of a storage capacity of the mobile terminal, it is very time-consuming if the rescan is performed each time when the connection recovers. Besides, system resources are occupied massively no matter whether the picture files of the mobile terminal are scanned again or an independent background process runs on the other terminal device to monitor the picture change of the mobile terminal.

### SUMMARY

Embodiments of the present invention provide a method and a device for managing pictures of a mobile terminal to solve a problem that system resources are occupied by picture scan or monitoring performed for the mobile terminal after the mobile terminal is reconnected with other terminal device.

Embodiments of the present invention put forward the following technical solutions:

An embodiment of the present invention provides a method for managing pictures of a mobile terminal, where a log file is maintained on the mobile terminal to record picture file and a picture file storage directory information. The method includes:

monitoring, by the mobile terminal, changes of picture files and a file storage directory of the picture files stored on the mobile terminal, and if any change is detected, updating the log file according to the detected change; and

providing, by the mobile terminal, the log file to other terminal device when the mobile terminal is connected to the other terminal device so that the other terminal device manages the picture files on the mobile terminal according to the log file.

Further, an embodiment of the present invention provides a mobile terminal, including:

a log storing module, configured to store a log file that records picture file and a picture file storage directory information;

a monitoring module, configured to monitor changes of picture files and a file storage directory of the picture files stored on the mobile terminal; and

a log updating module, configured to when the monitoring module detects any change, update the log file according to the detected change; whereupon

the mobile terminal submits the log file stored in the log storing module to other terminal device when the mobile terminal is connected to the other terminal device so that the other terminal device manages the picture files on the mobile terminal according to the log file.

Further, an embodiment of the present invention provides a machine-readable medium that stores an instruction set, where the machine can execute the method for managing pictures when the instruction set is executed.

Further, an embodiment of the present invention provides a picture management device, including: a memory, configured to store instructions and a log file that records picture file and a picture file storage directory information; and a processor, coupled to the memory and configured to execute the instructions in the memory and execute the method for managing pictures.

With the method and the device in the embodiments of the present invention, a log file is set on a mobile terminal to record changes of picture files and changes of a storage directory of the picture files by using an independent operation capability of the mobile terminal, so as to implement real-time monitoring on picture changes on the mobile terminal. Each time when the mobile terminal is connected with other terminal device, the other terminal device knows the changes of the pictures on the mobile terminal by only reading the log file, without rescanning picture data or running a monitoring process separately to monitor the picture changes of the mobile terminal. Therefore, synchronizing picture data on the mobile terminal is as simple and fast as synchronization on a local disk, and less system resources are occupied.

### BRIEF DESCRIPTION OF THE DRAWINGS

FIG. 1 is a schematic flowchart of a method for managing pictures of a mobile terminal according to an embodiment of the present invention;

FIG. 2 is a schematic diagram of a PC obtaining a log file on a mobile terminal according to an embodiment of the present invention; and

FIG. 3 is a schematic structural diagram of a mobile terminal according to an embodiment of the present invention.

### DETAILED DESCRIPTION OF THE EMBODIMENTS

Embodiments of the present invention put forward a solution in which a log file similar to an NTFS Change Journal is set by using an independent operation capability of a mobile terminal, and therefore, picture management software of other terminal device can manage pictures of the mobile terminal in the same way as managing local disks, where the log file is configured in a format encode-able and decodable by the picture management software of the other terminal device. In this way, even if the mobile terminal is disconnected and then reconnected to the other terminal device, it is not necessary to rescan picture files on the mobile terminal or restart a monitoring process to monitor picture changes of the mobile terminal. The other terminal device may be a portable terminal, a tablet, or a desktop computer. In the embodiments of the present invention, it is assumed that the other terminal device is a PC with picture management software.

The following clearly and completely describes the technical solutions of the present invention with reference to the accompanying drawings in the embodiments of the present invention. Apparently, the embodiments in the following description are merely a part rather than all of the embodiments of the present invention. All other embodiments obtained by persons of ordinary skill in the art based on the embodiments of the present invention without creative efforts shall fall within the protection scope of the present invention.

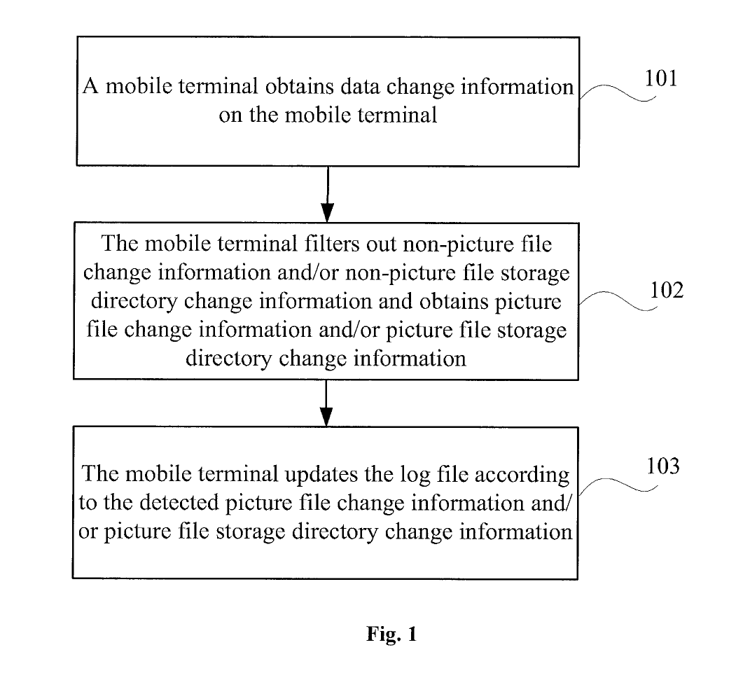

FIG. 1 is a schematic flowchart of a method for managing pictures of a mobile terminal according to an embodiment of the present invention. A log file is set on a mobile terminal. The log file records picture file information and/or picture file storage directory information on the mobile terminal, and is maintained by a file system. When data or a data storage directory change, a record is added in the log file to describe information of the changed data or data storage directory and type of the change such as creating, deleting, renaming, and so on. Each record is in the following format: modification time: change type: and path of the changed file. When the change type is “rename”, the format also includes a path of the renamed file. When a record is added, the record is added at the end of the log file.

As shown in FIG. 1, a method for managing pictures of a mobile terminal includes the following steps:

Step 101: A mobile terminal monitors file change information and/or file storage directory change information on the mobile terminal.

Specifically, the mobile terminal uses a monitoring module to monitor information on a system's invoking an API (Application Programming Interface), for example, monitor the system's invoking the API to perform operations such as creating and deleting, so as to obtain the file change information and/or the file storage directory change information. The file includes picture file and non-picture file.

Step 102: The mobile terminal filters out non-picture file change information and/or non-picture file storage directory change information and obtains picture file change information and/or picture file storage directory change information.

Specifically, when the monitoring module of the mobile terminal detects any change of the picture file or the picture file storage directory, a log updating module of the mobile terminal filters out the non-picture file change information or the non-picture file storage directory change information from a log file, and therefore, the log file retains picture file change information and/or picture file storage directory change information.

Preferably, the non-picture file change information or non-picture file storage directory change information may be filtered out in the following way:

Non-picture files may be filtered out by judging a filename suffix. For example, a list of suffixes of picture files supported by the mobile terminal is preset in the mobile terminal. When a file is added or deleted or a file attribute is changed, the mobile terminal compares a suffix of the changed file with the list of suffixes of picture files, and deletes files whose suffixes are not in the list of suffixes from the monitored file change information and/or file storage directory change information. When a file is moved from one directory to another, the mobile terminal compares a suffix of the changed file with the list of suffixes of picture files, and deletes files whose suffixes are not in the list of suffixes from the monitored file change information and/or file storage directory change information.

Step 103: The mobile terminal updates the log file according to the detected picture file change information and/or picture file storage directory change information.

Specifically, after the log updating module filters out the non-picture file change information or non-picture file storage directory change information from the log file, a log storing module of the mobile terminal stores the picture file change information or picture file storage directory change information to obtain an updated log file.

When the mobile terminal is connected to a PC, the mobile terminal submits the log file to the PC so that the PC manages the picture files on the mobile terminal according to the log file.

Preferably, when connected to the PC, the mobile terminal sends the log file to a picture management system on the PC so that the PC manages pictures of the mobile terminal according to the picture file change information and/or picture file storage directory change information in the log file.

When the mobile terminal is connected to the PC, the mobile terminal may also do not send the log file, but the picture management system on the PC scans the mobile terminal to obtain the log file, whereupon the PC manages the pictures of the mobile terminal according to the picture file change information and/or picture file storage directory change information in the log file.

Because the log file on the mobile terminal is updated in real time, when a picture file changes or a storage directory of the picture file changes, the mobile terminal detects the change and updates the log file. Therefore, when the mobile terminal is connected to a PC, the PC obtains current information about the picture file on the mobile terminal, and manages the pictures of the mobile terminal quickly and conveniently.

By using the independent operation capability of the mobile terminal and maintaining the log file, the mobile terminal monitors the picture file change information and/or picture file storage directory change information. Therefore, the monitoring is more punctual, the picture file change information on the mobile terminal is obtained in real time, the monitoring operation is performed by the mobile terminal, repeated scan or repeated monitoring for picture data is avoided, and less system resources are occupied.

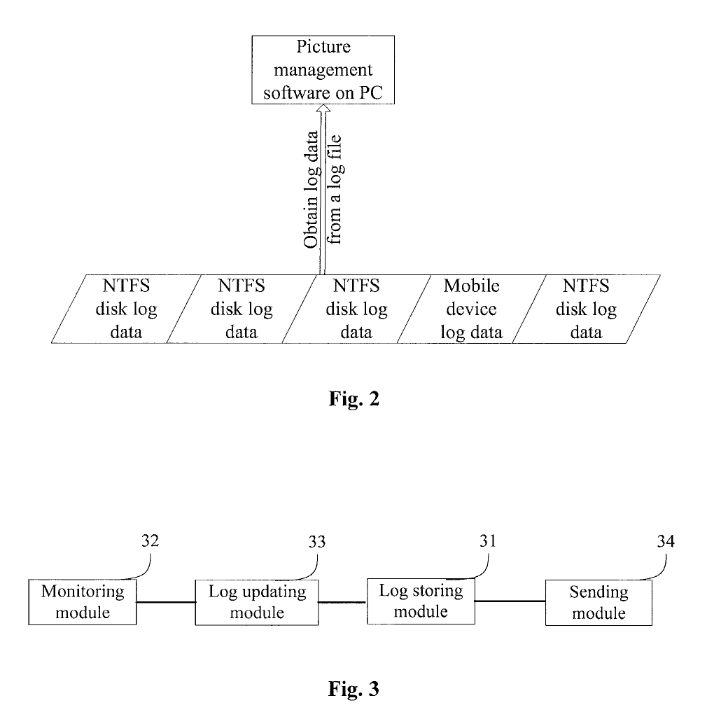

FIG. 2 is a schematic diagram of a PC obtaining a log file on a mobile terminal according to an embodiment of the present invention.

A log file “Change Journal” maintained by an NTFS file system is set on the PC. The “Change Journal” log file is configured on each disk partition of the PC for recording data change information on the disk partition. The Change Journal is a file on a volume. When a file or storage directory in a file system changes, a record is added into the log file. The record generally includes: a filename, change time, change type (creating, deleting, renaming, and so on). The actual data is not recorded. In this way, the log file is small enough. The picture management software on the PC can read the “Change Journal” log file of each disk in real time and obtain picture change information of the disk partition from the log file.

Similar to the Change Journal file maintained on the PC, the log file set on the mobile terminal is used to record data change information. When the mobile terminal is connected to the PC, the mobile terminal may be identified by the PC as a disk. The picture management software on the PC can read the log file on the mobile terminal, obtain the picture file change information and/or picture file storage directory change information of the mobile terminal, and manage pictures of the mobile terminal in the same way as managing a local disk. This method makes the picture management software on the PC handle picture synchronization on the mobile terminal in a completely transparent manner.

With the method for managing pictures of a mobile terminal in the embodiment of the present invention, a log file is set on the mobile terminal to record changes of picture files and changes of a storage directory of the picture files by using an independent operation capability of the mobile terminal, so as to implement real-time monitoring on picture changes on the mobile terminal. Each time when the mobile terminal is connected with other terminal device, the other terminal device knows the changes of the pictures on the mobile terminal by only reading the log file, without rescanning picture data or running a monitoring process separately to monitor the picture changes of the mobile terminal. Therefore, synchronizing picture data on a mobile terminal is as simple and fast as synchronization on a local disk, and less system resources are occupied.

Based on the same conception, an embodiment of the present invention provides a mobile terminal. As shown in FIG. 3, the terminal includes:

a log storing module 31, configured to store a log file that records picture file information and/or picture file storage directory information;

a monitoring module 32, configured to monitor changes of picture files and/or changes of a storage directory of the picture files; and

a log updating module 33, configured to update the log file according to the changes detected by the monitoring module 32 when the monitoring module 32 detects any change of the picture files or change of the storage directory of the picture files.

The mobile terminal submits the log file stored in the log storing module 31 to other terminal device when the mobile terminal is connected to the other terminal device so that the other terminal device manages the picture files on the mobile terminal according to the log file.

Specifically, the monitoring module 32 is configured to monitor file change information and/or file storage directory change information on the mobile terminal.

The log updating module 33 is specifically configured to filter out non-picture file change information and non-picture file storage directory change information and record picture file change information and/or picture file storage directory change information.

The log storing module 31 is specifically configured to store the log file that records the picture file change information and/or picture file storage directory change information obtained by the log updating module 33.

Specifically, a list of suffixes of picture files supported by the mobile terminal is preset in the mobile terminal. The log updating module 33 is configured to: when a file is added or deleted or a file attribute is changed, compare a suffix of the changed file with the list of suffixes of picture files, and delete files whose suffixes are not in the list of suffixes from the monitored file change information and/or file storage directory change information; when a file is moved from one directory to another, compare a suffix of the changed file with the list of suffixes of picture files, and delete files whose suffixes are not in the list of suffixes from the monitored file change information and/or file storage directory change information.

The mobile terminal further includes a sending module 34, configured to send the log file stored in the log storing module 31 to a picture management system on the other terminal device when the mobile terminal is connected to the other terminal device.

Further, an embodiment of the present invention provides a picture management device. The picture management device may be a smartphone, a tablet, or a handwriting computer, and the picture management device includes: a memory, configured to store instructions and a log file that records picture file and a picture file storage directory information; and a processor, coupled to the memory. The processor is configured to execute the instructions in the memory and execute various embodiments of the method for managing pictures.

Those skilled in the art should understand that the modules in the device provided in the embodiment of the present invention may be distributed in the device in the way described herein, or may be located in one or more devices in a different way. The modules may be combined into one, or divided into multiple sub-modules.

According to the description of the embodiments above, those skilled in the art understand that the present invention may be implemented by hardware only, or preferably in most circumstances, by software and a hardware platform. The essence of the technical solutions of the present invention or the parts contributing to the prior art may be embodied in a software product. The software product is stored in a storage medium such as a computer floppy disk, hard disk or optical disk, and includes a number of instructions, where the instructions make a terminal device (for example, mobile phone, personal computer, server, or network device) execute the methods according to the embodiments of the present invention. Alternatively, a general-purpose hardware device is configured as the device disclosed in the embodiments of the present invention to implement the solutions disclosed in the embodiments of the present invention.

It should be noted that the above-mentioned embodiments are merely the preferred embodiments of the present invention, and persons having ordinary skill in the art may make various improvements and refinements without departing from the principle of the present invention. All such modifications and refinements are intended to be covered by the scope of the present invention.

1. A method for managing pictures of a mobile terminal, the method comprising:
monitoring, by the mobile terminal, changes of picture files and a file storage directory of the picture files stored on the mobile terminal, and if any change is detected, updating a log file according to the detected change, wherein the log file is maintained on the mobile terminal to record picture file and a picture file storage directory information; and
providing, by the mobile terminal, the log file to other terminal device when the mobile terminal is connected to the other terminal device so that the other terminal device manages the picture files on the mobile terminal according to the log file.

2. The method according to claim 1, wherein the updating the log file according to the detected changes further comprises:
filtering out, by the mobile terminal, non-picture file change information and non-picture file storage directory change information to obtain picture file change information and picture file storage directory change information; and
recording, by the mobile terminal, the picture file change information and the picture file storage directory change information into the log file.

3. The method according to claim 2, further comprises storing in the mobile terminal a list of suffixes of picture files supported by the mobile terminal, and the filtering out, by the mobile terminal, non-picture file change information and/or non-picture file storage directory change information.

4. The method of claim 3 further comprises comparing, by the mobile terminal when a file is added or deleted or a file attribute is changed, a suffix of the changed file with the list of suffixes of picture files, and deleting files whose suffixes are not in the list of suffixes from the detected file and file storage directory change information.

5. The method of claim 3 further comprises comparing, by the mobile terminal when a file is moved from one file storage directory to another, a suffix of the changed file with the list of suffixes of picture files, and deleting files whose suffixes are not in the list of suffixes from the detected file and file storage directory change information.

6. The method according to claim 1, wherein the providing, by the mobile terminal, the log file to the other terminal device comprises:
sending the log file to a picture management system on the other terminal device when the mobile terminal is connected to the other terminal device; or
scanning, by the picture management system on the other terminal device, the mobile terminal to obtain the log file when the mobile terminal is connected to the other terminal device.

7. The method according to claim 1, wherein the providing, by the mobile terminal, the log file to the other terminal device comprises:
scanning, by the picture management system on the other terminal device, the mobile terminal to obtain the log file when the mobile terminal is connected to the other terminal device.

8. A mobile terminal, comprising:
a log storing module, configured to store a log file that records picture file and a picture file storage directory information;
a monitoring module, configured to monitor changes of picture files and a file storage directory of the picture files stored on the mobile terminal; and
a log updating module, configured to when the monitoring module detects any change, update the log file according to the detected change.

9. The mobile terminal according to claim 8, wherein
the log updating module is specifically configured to filter out non-picture file change information and non-picture file storage directory change information and record picture file change information and picture file storage directory change information; and
the log storing module is specifically configured to store the log file that records the picture file change information and picture file storage directory change information obtained by the log updating module.

10. The mobile terminal according to claim 9, wherein
a list of suffixes of picture files supported by the mobile terminal is stored in the mobile terminal; and
the log updating module is configured to: compare, when a file is added or deleted or a file attribute is changed, a suffix of the changed file with the list of suffixes of picture files, and delete files whose suffixes are not in the list of suffixes from the detected file and file storage directory change information; and/or, compare, when a file is moved from one file storage directory to another, a suffix of the changed file with the list of suffixes of picture files, and delete files whose suffixes are not in the list of suffixes from the detected file and file storage directory change information.

11. The mobile terminal according to claim 8, further comprising:
a sending module, configured to send the log file stored in the log storing module to a picture management system on other terminal device when the mobile terminal is connected to the other terminal device so that the other terminal device manages picture files on the mobile terminal according to the log file.

12. A picture management device, comprising:
a memory, configured to store instructions and a log file that records picture file and a picture file storage directory information; and
a processor, coupled to the memory and configured to execute the instructions in the memory and monitor changes of picture files and a file storage directory of the picture files stored on a mobile terminal, and if any change is detected, update the log file according to the detected changes, whereupon the mobile terminal provides the log file to other terminal device when the mobile terminal is connected to the other terminal device so that the other terminal device manages the picture files on the mobile terminal according to the log file.

13. The device according to claim 12, wherein the processor is further configured to:
filter out non-picture file change information and non-picture file storage directory change information to obtain picture file change information and picture file storage directory change information; and
record the picture file change information and the picture file storage directory change information into the log file.

14. The device according to claim 13, wherein a list of suffixes of picture files supported by the terminal is stored in the memory, and the processor is further configured to:
compare a suffix of a changed file with the list of suffixes of picture files when a file is added or deleted or a file attribute is changed, and delete files whose suffixes are not in the list of suffixes from the detected file and file storage directory change information.

15. The device according to claim 13, wherein a list of suffixes of picture files supported by the terminal is stored in the memory, and the processor is further configured to compare a suffix of a changed file with the list of suffixes of picture files when a file is moved from one file storage directory to another, and delete files whose suffixes are not in the list of suffixes from the detected file and file storage directory change information.

16. The device according to claim 12, wherein the processor is further configured to:
send the log file to a picture management system on the other terminal device when the terminal is connected to the other terminal device.

17. The device according to claim 12, wherein the processor is further configured to enable the picture management system on the other terminal device to scan the mobile terminal to obtain the log file when the terminal is connected to the other terminal device.

18. The device according to claim 12, wherein the other terminal device is one of a portable computer and a desktop computer.
